(19) United States
(12) Patent Application Publication
(10) Pub. No.: US 2021/0126847 A1
(43) Pub. Date: Apr. 29, 2021

(54) REPOSITORY FOR TELEMETRY DATA

(71) Applicant: Microsoft Technology Licensing, LLC, Redmond, WA (US)

(72) Inventors: Gregory Irving THIEL, Black Diamond, WA (US); Konstantin E. RYVKIN, Bellevue, WA (US)

(73) Assignee: Microsoft Technology Licensing, LLC, Redmond, WA (US)

(21) Appl. No.: 16/667,765

(22) Filed: Oct. 29, 2019

(51) Int. Cl. H04L 12/26; G06F 9/54

(52) U.S. Cl. CPC H04L 43/065; G06F 9/54

(57) ABSTRACT

A network repository comprises a network communications interface configured to communicatively couple the network repository with a client device, a service entity, and an intermediate network device. The intermediate network device is configured to facilitate a network communication between the client device and the service entity. The network repository includes a logic machine and a storage machine. The storage machine holds instructions executable by the logic machine to receive telemetry data from a reporting entity including one of the client device, service entity, and the intermediate network device. Furthermore, the instructions are executable to store the telemetry data. Further still, the instructions are executable to provide a set of the telemetry data to a requesting entity other than the reporting entity when a request is received from the requesting entity.

### BACKGROUND

Network communications between computing devices can be disrupted due to network congestion, device misconfigurations, hardware failures, or other factors. Normal network communications involve many disparate devices, such as client devices, service devices, and intermediate network devices (e.g., network routers) that all play a part in the network communications.

### SUMMARY

A network repository comprises a network communications interface configured to communicatively couple the network repository with a client device, a service entity, and an intermediate network device. The intermediate network device is configured to facilitate a network communication between the client device and the service entity. The network repository includes a logic machine and a storage machine. The storage machine holds instructions executable by the logic machine to receive telemetry data from a reporting entity including one of the client device, service entity, and the intermediate network device. Furthermore, the instructions are executable to store the telemetry data. Further still, the instructions are executable to provide a set of the telemetry data to a requesting entity other than the reporting entity when a request is received from the requesting entity.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically illustrates a network communication between a client device and a service entity.

FIG. 2 schematically shows an example client device, service entity, intermediate network device, and network repository.

FIG. 3 schematically shows an example client device, service entity, intermediate network device, management plane device, and network repository.

FIG. 4 schematically illustrates telemetry data received by a network repository from a reporting entity.

FIG. 5 schematically illustrates telemetry data received by a network repository from a management plane device.

FIG. 6 schematically depicts storage of telemetry data by the network repository.

FIG. 7 schematically illustrates a set of telemetry data sent by a network repository to requesting entities.

FIG. 8 illustrates an example method for a network repository.

FIG. 9 illustrates an example method for a service entity.

FIG. 10 illustrates an example method for a client device.

FIG. 11 schematically shows an example computing system.

### DETAILED DESCRIPTION

Telemetry data collected by devices participating in a network communication may be useful for identifying device failures, resolving connection issues, improving network utilization, or otherwise improving the network experience of a client device. However, in many cases, devices involved in a network communication do not share relevant telemetry data with one another—for instance, because the devices are owned or operated by different parties (e.g., individuals or organizations). This can complicate attempts by any particular party to diagnose and resolve network problems, as relevant telemetry data may be isolated to devices that are inaccessible to the diagnosing party.

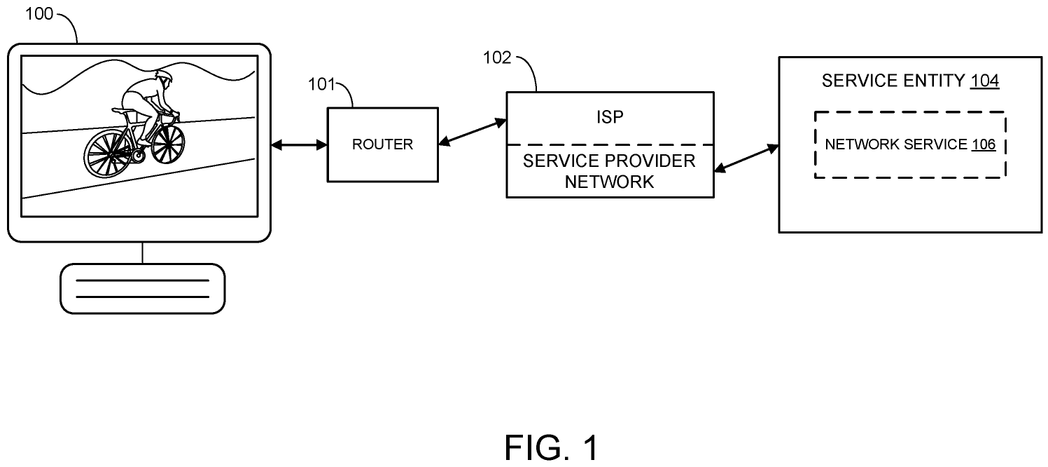

For example, FIG. 1 schematically illustrates a network communication between a client device 100 and a service entity 104 over a network 102. Data from the client device is transmitted to network 102 via a client router 101. In this example, the network is the Internet, and network 102 includes devices maintained by an internet service provider (ISP) and a cloud service provider network. Service entity 104 is providing a network service 106, which in this example is a video stream. Thus, in this example, the network communication involves client device 100 streaming digital video content from network service 106.

However, as discussed above, should client device 100 experience a loss of quality or disruption to the streaming video, it can be difficult to resolve the problem to a particular cause. For instance, the issue could be caused by a network interface of client device 100, a failure or misconfiguration of one or more devices associated with service entity 104, network congestion, or any number of other potential problems with network 102. During the network communication, each of client device 100, service entity 104, and any network devices associated with network 102 (e.g., routers), may each be capable of independently observing/recording potentially relevant telemetry data. However, the ability of any particular party (e.g., a user of client device 100 or an operator of service entity 104) to diagnose the problem may be limited if such data is observed/recorded but not shared with other participating parties. Even when no specific faults or failures occur, the client experience may nonetheless be improved via sharing of telemetry data, as such data may be input to analysis or optimization logic.

Accordingly, the present disclosure is directed to a network repository configured to store telemetry data received from various reporting entities. For instance, for a particular network communication involving a client device, a service entity, and one or more intermediate network devices, any or all of the involved entities may send telemetry data for storage by the network repository. In other words, as the network communication is ongoing, any or all of the involved devices may collect telemetry data. Such telemetry data may then be sent to a network repository, either in raw form or after some analysis has occurred. The network repository may therefore serve as a common repository of telemetry data accessible to any or all participants in a particular network communication. By requesting sets of telemetry data from the network repository, interested parties may obtain telemetry data they might not otherwise have access to, allowing for more efficient diagnosis and remediation of potential network issues. Furthermore, sharing of telemetry data across device and provider boundaries in this manner can be used to improve the client experience in general. For instance, telemetry data provided by multiple parties can be input into optimization logic, which may identify one or more potential network changes that, when implemented, are predicted to improve a network experience of the client device. Additionally, or alternatively, human users may manually interpret the telemetry data to draw human-based conclusions as to how the network experience of the client may be directly or indirectly improved.

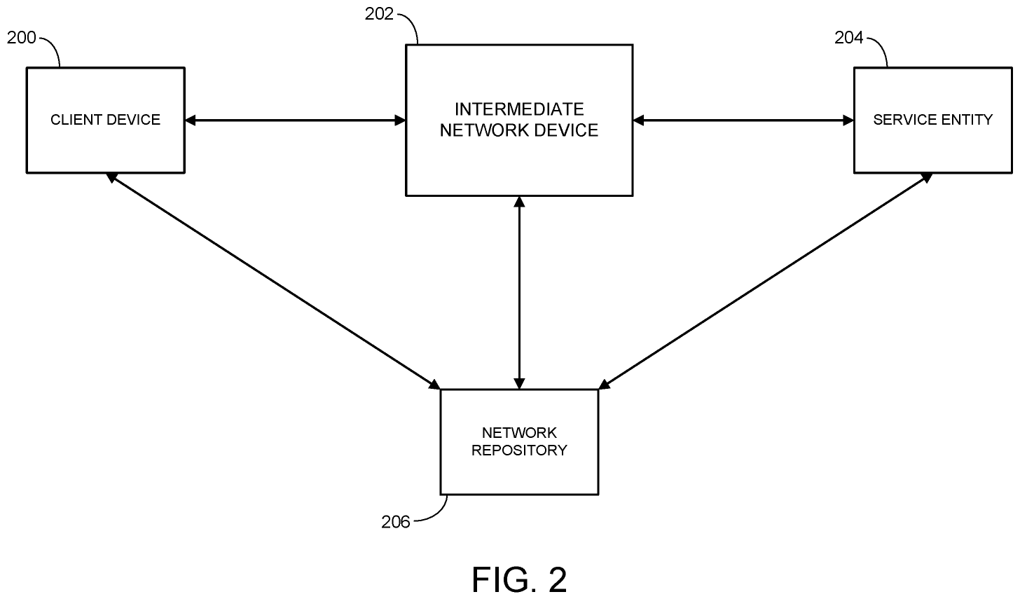

FIG. 2 schematically illustrates a network communication between a client device 200 and a service entity 204, the network communication is facilitated by an intermediate network device 202. In other words, in FIG. 2, there is ongoing network communication between the client device and service entity, which is transmitted or relayed by the intermediate network device. At the same time, each of entities 200, 202, and 204 are communicatively coupled with a network repository 206, which may receive telemetry data from any or all of entities 200, 202, and 204. For example, as the network communication between the client device and service entity is ongoing, any or all of entities 200, 202, and 204 may send telemetry data to the network repository, for instance via a side channel.

The client device, service entity, network repository, and intermediate network device may communicate in any suitable way and over any suitable computer network, including local networks and wide area networks (e.g., the Internet). Any or all associated physical devices may communicate over wired connections and/or wireless connections. The network communication between the client device and service entity may take any suitable form, including any type and quantity of computer data, and persist for any length of time. The network communication may be bidirectional or unidirectional. As examples, the network communication may include Internet protocol suite (TCP/IP) and/or hypertext transfer protocol (HTTP) traffic between the client device and service entity, streaming digital media (e.g., audio and/or video), peer-to-peer data exchange, a voice over IP (VoIP) call, and/or any other type of network traffic.

As used herein, the term “entity” refers to a collection of one or more physical devices that are owned or operated by the same user/party/organization, including computing devices and/or network devices. For example, a service entity may include a plurality of individual devices owned or operated by a cloud service provider, such that the plurality of individual devices work cooperatively to provide a network service and communicate with clients. Any or all physical devices described herein, including computing devices and network devices, may have any suitable form factor and hardware configuration. Thus, in FIG. 2, service entity 204 may schematically represent a plurality of individual physical devices, each performing different functions related to providing a network service.

Typically, the service entity will include one or more devices configured to provide some type of network-accessible application or other service. For instance, the client device may be a user computing device (e.g., laptop, desktop, smartphone, tablet, augmented/mixed reality device), while the service entity may include one or more web servers, or any other network-accessible computing devices. Additionally, or alternatively, a “client device” may include a client router. The intermediate network device may be any suitable device that enables, facilitates, or otherwise participates in the network communication. For instance, the intermediate network device may be a network router, switch, modem, relay, or server. Only one intermediate network device is shown for the sake of simplicity, but it is understood that many different intermediate network devices may cooperate to facilitate communication between a client device and a service entity. Further, different network routes that utilize different intermediate network devices may be available, and such routes may be dynamically changed such that the client device and service entity utilize different intermediate network devices at different times.

The network repository may be implemented by any network-accessible device or system of devices capable of receiving telemetry data, storing telemetry data, and providing sets of telemetry data to requesting entities, as will be discussed in more detail below.

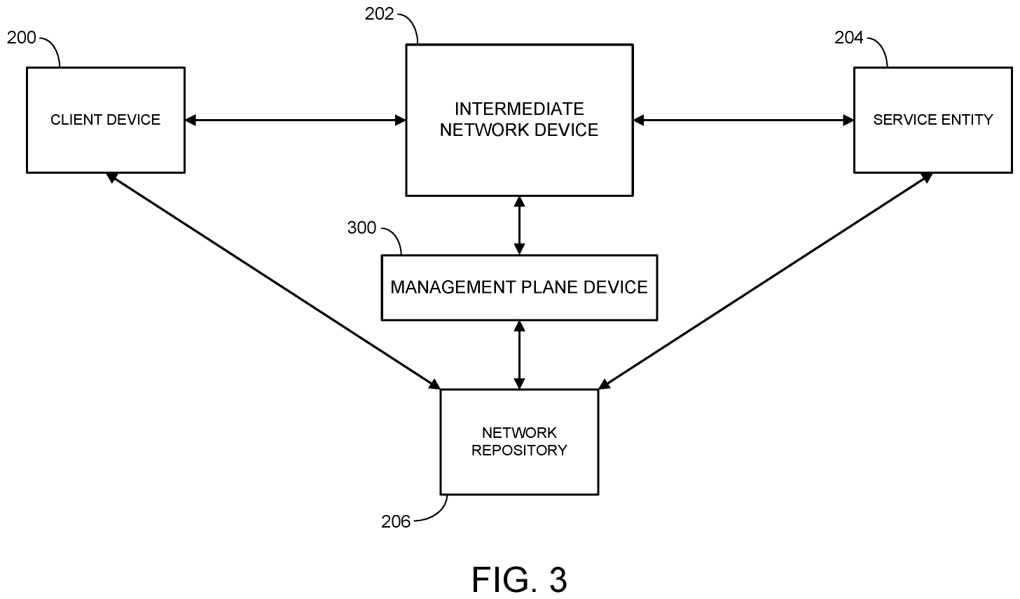

FIG. 3 schematically illustrates a different example network communication between client device 200 and service entity 204, the network communication facilitated by intermediate network device 202. In this example, however, data exchanged between the intermediate network device and network repository flows through a management plane device 300. Management plane device 300 may, for example, be a management server configured to manage operations of a plurality of different network devices, including intermediate network device 202. For example, management plane device 300 may access telemetry data from the network repository, and use such telemetry data to change policies for the intermediate network device to improve the client experience.

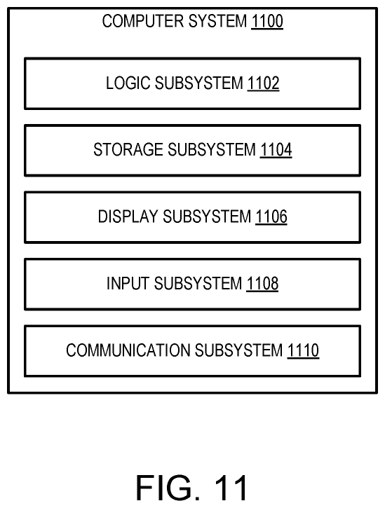

Any or all of the physical devices described herein, including the client device, intermediate network device, management plane device, any devices associated with the service entity, and any devices associated with the network repository may in some cases be implemented as computing system 1100 described below with respect to FIG. 11.

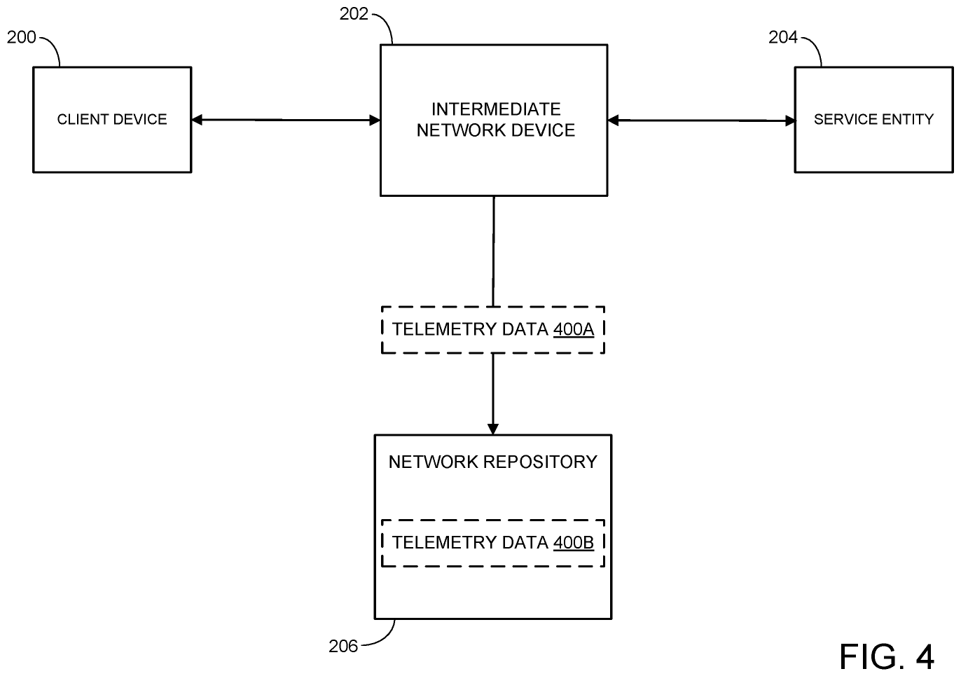

FIG. 4 again schematically shows client device 200, intermediate network device 202, service entity 204, and network repository 206. As shown in FIG. 4, the network repository receives telemetry data 400A from a reporting entity. In this example, the reporting entity is the intermediate network device. In general, the network repository may be configured to receive telemetry data from any devices associated with any reporting entities, including the client device, service device, and other network devices.

The telemetry data may include any variety of information pertaining to the network communication and/or reporting entity. For instance, the telemetry data may include a unique device identifier for a network device maintained by the reporting entity and/or other devices involved in the network communication, such as an IP address. The telemetry data may include configuration details for the network device that are infrequently changed, such as its hardware configuration, model number, installed software applications, operating system build, and/or number of supported network connections. Additionally, or alternatively, the telemetry data may include information that is updated or changed over time, such as a number of packets sent/received/dropped by the network device, a bandwidth utilized by the network device, any error codes recorded by the network device, a network latency or jitter observed by the network device, a number of currently open network connections, etc. In the case of information that is updated or changed over time, the telemetry data may include a timestamp. In some implementations, the telemetry data may be cryptographically signed.

For instance, as discussed above, the intermediate network device may in some cases take the form of a network router, which may be operated by an Internet service provider (ISP). Thus, the reporting entity may be the ISP, and the telemetry data may include information collected by the ISP while facilitating the network communication between the client device and service entity. Notably, the telemetry data may be submitted by and include information pertaining to any devices associated with the ISP, not only a network router involved in a particular network communication. Additionally, or alternatively, the telemetry data may include information collected by a manufacturer, owner, or operator of the network router, a provider or developer of any software installed or running on the network router, etc.

The telemetry data may be organized and transmitted in any suitable way. In some cases, the telemetry data may be received via an application programming interface (API) of the network repository. Further, the telemetry data may be organized or formatted according to a schema supported by the API. In some cases, the information included in the telemetry data may be subject to a service agreement or contract between one or more of the parties involved in the network communication. For instance, each involved party may agree to submit at least a minimum amount of telemetry data for each network communication, in exchange for access to telemetry data collected by the other parties. In other examples, however, there may be no limitations or restrictions on the amount, type, and formatting of the telemetry data, and each involved party may choose to provide as much or as little telemetry data as is desired.

As shown in FIG. 4, the network repository is already storing second telemetry data 400B, which may include different information than first telemetry data 400A. In some cases, the second telemetry data may describe or pertain to the same network communication as the first telemetry data, and may be received from the same reporting entity (i.e., the intermediate network device). Alternatively, the second telemetry data may refer to a different network communication, and/or may be received from a different reporting device (e.g., the client device or service device). Either or both of the first and second telemetry data may include aggregated telemetry data from any number of different network communications.

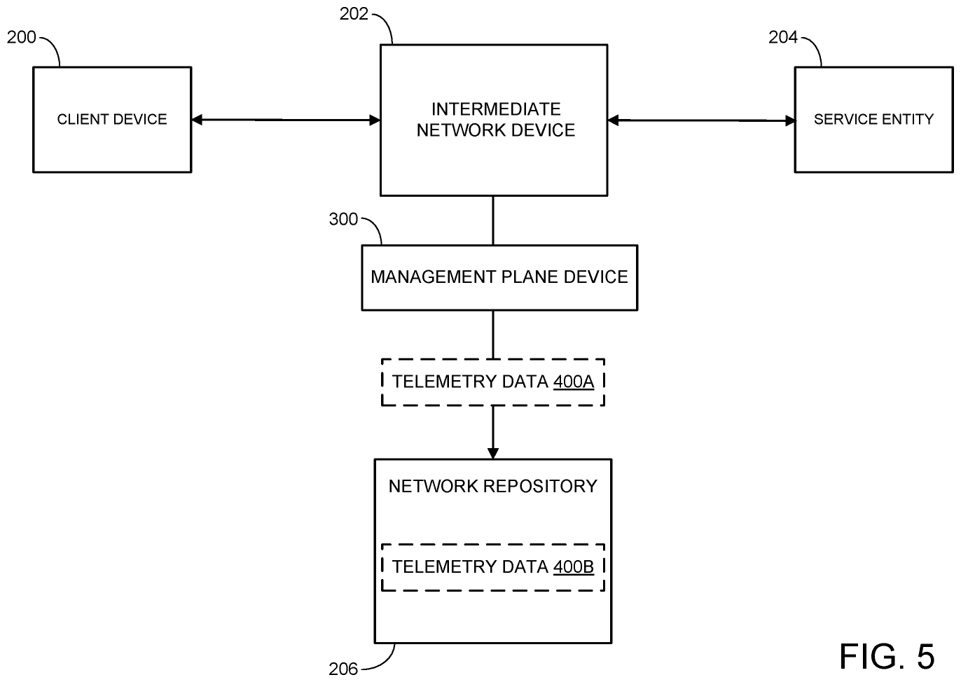

FIG. 5 schematically illustrates a different example network communication between client device 200 and service entity 204, facilitated by intermediate network device 202. As with FIG. 3, in this example the telemetry data flows through a management plane device 300. Management plane device 300 may, for example, be a management server configured to manage operations of a plurality of different network devices, including intermediate network device 202. For example, management plane device 300 may access telemetry data from the network repository, and use such telemetry data to change policies for the intermediate network device to improve the client experience.

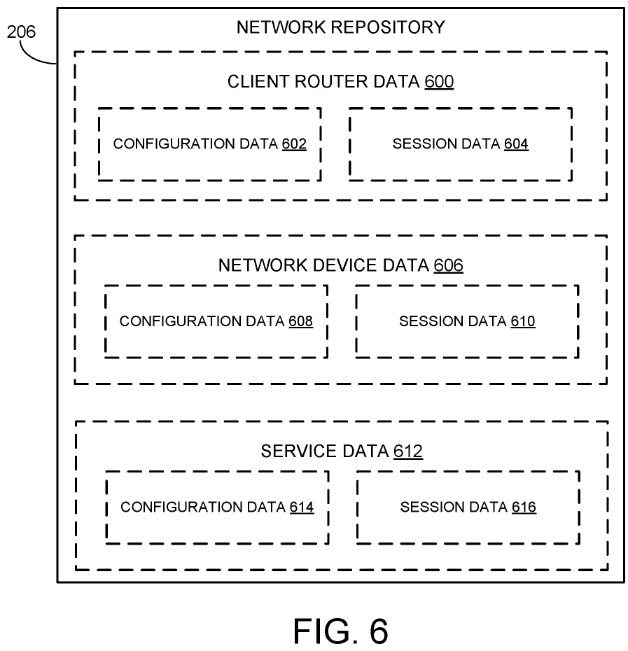

Storage of telemetry data is illustrated in FIG. 6, which again schematically shows network repository 206. In this example, telemetry data received from one or more reporting entities is organized both by device type and by data type. The telemetry data may additionally or alternatively be organized by tenant and/or by device instance. In FIG. 6, one set of data 600 corresponds to telemetry data received from or pertaining to a client router. The data includes a set of configuration data 602 and session data 604. As discussed above, the configuration data may include data that is only changed infrequently, such as the device's model number, operating system build, unique device identifier (e.g., IP address), etc., while the session data may include information that is updated frequently, or is otherwise specific to a particular network communication, such as an amount of bandwidth utilized, a number of packets sent/received/dropped, an observed network latency/jitter, etc. Network repository 206 also includes a second set of data 606 that is received from or pertains to the network device, which also includes a set of configuration data 608 and a set of session data 610. Further, network repository 206 includes a third set of data 612 that is received from or pertains to the service entity (e.g., one or more specific devices included in the service entity), also including configuration data 614 and session data 616. It will be understood, however, that the telemetry data in the network repository may originate from any party in the path of the network communication between the client and service entity, including, as examples, the client, the service entity, and any network routers/ISPs along the communication path.

As additional examples, telemetry data may include an indication that a device configuration has changed, the potential capacity of a given network link, or error information related to actions performed by a device. Telemetry data received from a service entity may include, as examples, feedback related to the quality of various protocol experiences or directives on actions that network devices might take to improve the client experience.

Telemetry data held by the network repository may be organized in any suitable way. In some cases, telemetry data may be stored as binary large objects (BLOBs) organized as shown in FIG. 6, such that each BLOB corresponds to a device type of the device that the telemetry pertains to, and a data type of the telemetry data included in the network telemetry. Thus, the data may be organized according to a hierarchical namespace. In other examples, the telemetry data may be stored in other suitable ways, such as in a relational database.

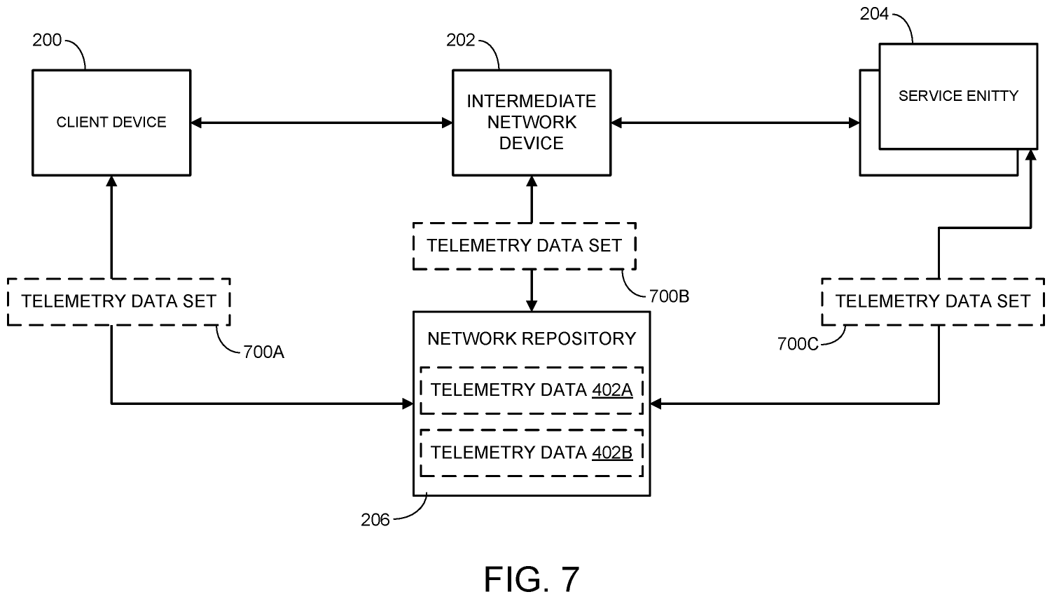

Turning now to FIG. 7, the network repository receives a request for a set of the telemetry data stored by the network repository from one or more requesting entities. In this example, the network communication between the client device and service entity is still ongoing, as indicated by the double-sided arrows between the client device, intermediate network device, and service entity. In other examples, however, the request for the set of telemetry data may be received after a particular network communication has ended. Thus, the request may solicit aggregated telemetry data for one or more network communications, including the recently ended network communication. Furthermore, the service entity is receiving a set of telemetry data from the network repository via a side channel.

It will be understood that a “set of telemetry data” need not include any insights or conclusions generated by the network repository. Rather, a “set of telemetry data” may simply include raw data collected by the network repository from one or more reporting entities, with no additional analysis or conclusions. Furthermore, it will be understood that the network repository need not take any specific action in response to a request from a requesting entity. Rather, in some cases, the network repository may simply publish its collected telemetry data, or otherwise make such telemetry data available to network parties. In such cases, receiving a “request” for a set of telemetry data may simply involve the requesting entity accessing already published data. Furthermore, telemetry data need not be accessed/retrieved by specific network devices themselves, but rather by a management plane for the device or entity in question—e.g., management plane device 300 shown in FIGS. 3 and 5.

In this example, each of the client device, intermediate network device, and service entity have requested sets of telemetry data. Notably, a requesting entity may be different form a reporting entity, as each of the client device and service entities are requesting entities. In some cases, a management plane may serve as a requesting entity. A reporting entity may also request a set of the telemetry data stored by the network repository, for instance to obtain telemetry data sent to the network repository by other parties—e.g., network device 202. Furthermore, in this example, each requesting entity is a participant in the network communication between the client device and service entity, although this need not always be the case. Rather, depending on the implementation, sets of telemetry data may be available to any requesting entity, or restricted to only requesting entity that have a stake in the requested information (e.g., because the requesting entity was a participant in the network communication). When access restrictions are implemented, such restrictions may be enforced using cryptographically verifiable digital signatures and/or other credential checks.

In response to the request, the network repository provides a set of telemetry data 700 to each requesting device—specifically, telemetry data sets 700A-C are sent to the client device, network device, and service entity. Notably, as discussed above, a “service entity” will typically include one or more hardware devices working cooperatively to provide a network-accessible application or service. Thus, the particular service device that engages in the network communication with the client device and intermediate network device may be different from the service device that reads telemetry data from the network repository, and yet both service devices may be part of the same service entity. This is illustrated in FIG. 7, as two boxes are shown for service entity 204, indicating two different physical devices. One device communicates with intermediate network device 202 and the other accesses telemetry data set 700C from the network repository.

Again, the network repository need not take any particular action to “provide” the set of telemetry data to a particular requesting entity, and in some cases the requesting entity may simply access already published or available data. The set of telemetry data may include any suitable information. In some examples the set of telemetry data may include telemetry data originally provided by two or more reporting entities, and thus the set of telemetry data may include more telemetry data than any one reporting entity would otherwise have access to. In this manner, telemetry data may be shared across device, management plane, and entity boundaries, allowing a client experience to be improved via analysis of the telemetry data. As with the telemetry data sent to the network repository, the set of telemetry data provided to the requesting entity may in some cases be requested via an API of the network repository, and may be organized/formatted in a manner supported by the API. Furthermore, the amount of data included in the set of telemetry data may in some cases be determined by service contracts or agreements between various parties involved in a network communication.

In general, however, a set of telemetry data may include any type and amount of telemetry data pertaining to one or more network communications and may be organized/formatted in any suitable way. For example, it will be understood that a set of telemetry data need not include data for only a single network communication, but rather may include data that is aggregated over time and based on multiple network communications. In some examples, a set of telemetry data may include the raw, unmodified output of one or more sets of telemetry data previously received by the network repository from one or more reporting entities. As an alternative, the set of telemetry data may include any information specifically requested by the requesting entity (e.g., via API calls for specific data), which may include data from multiple sets of received telemetry data, and omit data not specifically requested.

In some cases, access to the raw data held by the network repository may be limited and only provided in accordance with service contracts or agreements. For example, policies may be in place that restrict telemetry data only to devices and parties that provide their own sets of telemetry data to the repository, and/or have implemented procedures to safely secure the telemetry data they are requesting (e.g., requiring anonymization, encryption, and/or limits on retention). Furthermore, the set of telemetry data requested by the requesting entity may in some cases include only conclusions derived from the sets of telemetry data received by the network repository, rather than include raw telemetry data. For instance, the network repository may be configured to receive telemetry data from reporting entities, and analyze such data to determine the likely cause of a given network issue. The results of this analysis may then be included in the set of telemetry data sent to the requesting entity.

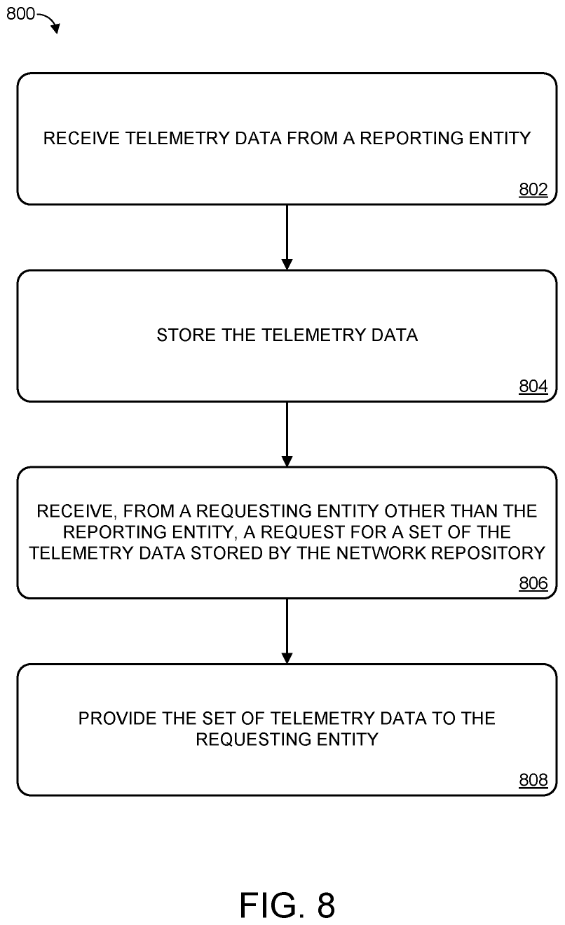

FIG. 8 illustrates an example method for a network repository. As discussed above, the network repository may be implemented on one or more physical devices having any suitable hardware configuration and form factor, and may in some cases be implemented as computing system 1100 described below with respect to FIG. 11.

At 802, method 800 includes receiving telemetry data from a reporting entity. The telemetry data describes or pertains to a network communication between a client device and a service entity. The reporting entity may include any of the client device, one or more devices associated with the service entity, and an intermediate network device that facilitates the network communication.

At 804, the telemetry data is stored by the network repository. The telemetry data may be organized and stored in any way, including as a BLOB or in a relational database.

At 806, method 800 includes receiving, from a requesting entity other than the reporting entity, a request for a set of telemetry data stored by the network repository. The requesting entity may be any of the client device, one or more devices associated with the service entity, and intermediate network device, or another device/party that was uninvolved in the network communication.

At 808, method 800 includes providing the set of telemetry data to the requesting entity. The set of telemetry data may include any or all telemetry data reported to the repository by one or more different reporting entities. The set of telemetry data may in some cases be tailored or filtered based on permissions or service agreements in place with an owner/operator of the requesting entity.

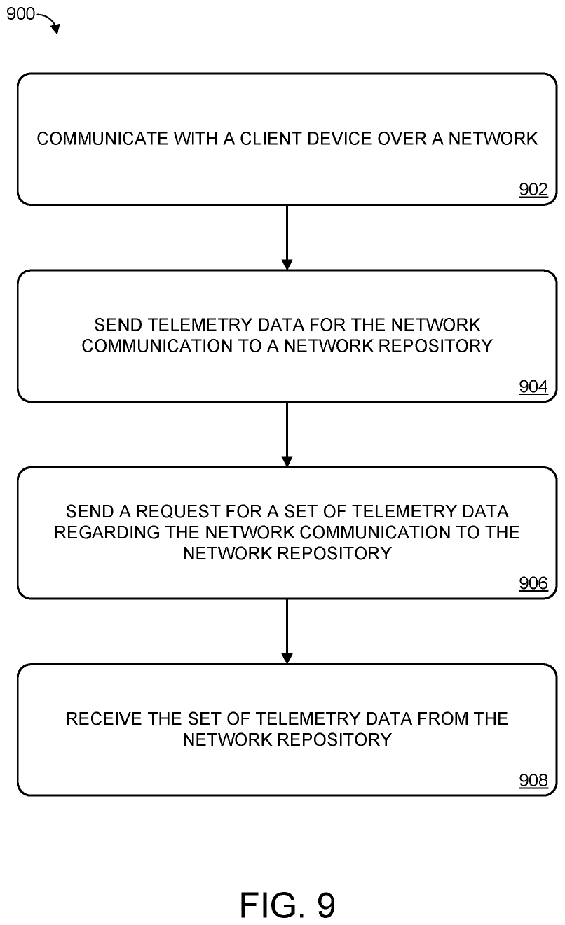

FIG. 9 illustrates an example method 900 for one or more devices associated with a service entity. As discussed above, the one or more devices associated with the service entity that implement method 900 may have any suitable hardware configuration and form factor, and may in some cases be implemented as computing system 1100 described below with respect to FIG. 11.

At 902, method 900 includes communicating with a client device over a network. The network communication may be facilitated by one or more intermediate network devices. The network communication may include any type and quantity of data and may persist for any length of time.

At 904, method 900 includes sending telemetry data for the network communication to a network repository. The telemetry data is observed/collected by the service entity during one or more current or prior network communications. The telemetry data may be formatted/organized in any suitable way and may be submitted via an API of the network repository. The telemetry data need not be sent to the network repository in real-time, but rather may be aggregated over time.

At 906, method 900 includes sending a request for a set of telemetry data regarding the network communication to the network repository. The set of telemetry data may include telemetry data provided by one or both of the client device and the intermediate network device.

At 908, method 900 includes receiving the set of telemetry data from the network repository. The information included in the set of telemetry data may in some cases be tailored or filtered based on permissions or service agreements that the service entity is subject to.

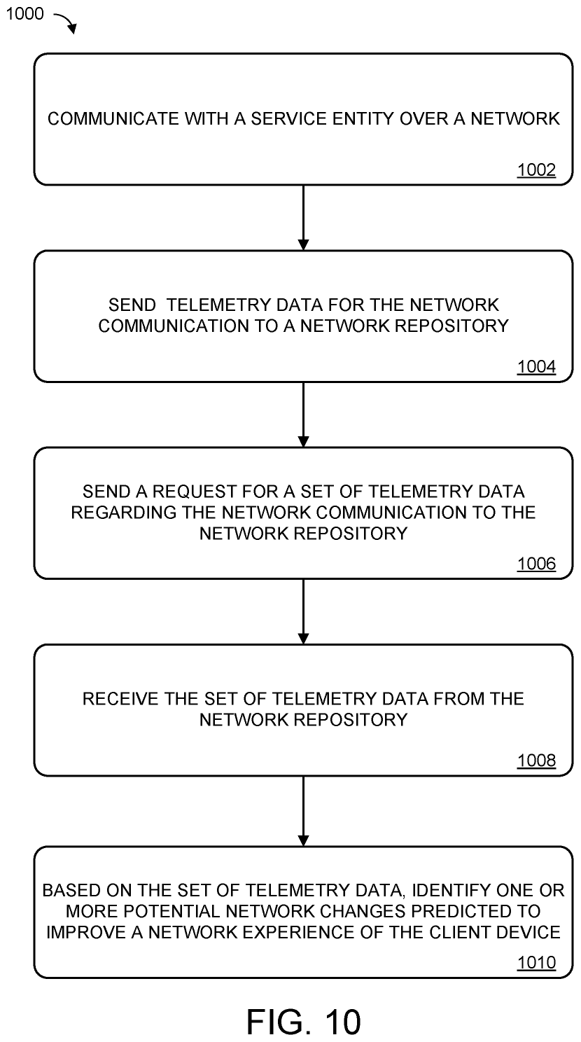

FIG. 10 illustrates an example method 1000 for a client device. As discussed above, the client device may have any suitable hardware configuration and form factor, and may in some cases be implemented as computing system 1100 described below with respect to FIG. 11. The client device may include one or both of a user computing device (e.g., desktop or laptop) and a network device (e.g., client router).

At 1002, method 1000 includes communicating with a service entity over a network. The network communication may be facilitated by one or more intermediate network devices. The network communication may include any type and quantity of data and may persist for any length of time.

At 1004, method 1000 includes sending telemetry data for the network communication to a network repository. The telemetry data is observed/collected by the client device during one or more current or prior network communications. The telemetry data may be formatted/organized in any suitable way and may be submitted via an API of the network repository.

At 1006, method 1000 includes sending a request for a set of telemetry data regarding the network communication to the network repository. The set of telemetry data may include telemetry data provided by one or both of the service entity and the intermediate network device.

At 1008, method 1000 includes receiving the set of telemetry data from the network repository. The information included in the set of telemetry data may in some cases be tailored or filtered based on permissions or service agreements that the client device is subject to.

At 1010, method 800 includes, based on the set of telemetry data, identifying one or more potential network changes that, when implemented, are predicted to improve a network experience of the client device. Such network changes may take any suitable form and may be identified in any suitable way. As one example, the client device may analyze or interpret the telemetry data to identify issues or failures in the network causing communication problems. Thus, the potential network changes can include resolving errors (e.g., restarting specific devices, changing configuration settings), shifting some to all network traffic to use a different network path, or changing the way that network traffic is formatted, packaged, or otherwise transmitted. Such potential network changes may be identified manually by a human and/or automatically via suitable machine learning or artificial intelligence techniques. Furthermore, improving the client experience need not include resolving any particular problem, but rather may be preemptive or quality-of-life changes. For example, the client device may determine that a current network path is sufficient, but the client experience could be better if a different network path were used. Notably, in many cases, the potential network changes are only identified because telemetry data from multiple reporting entities is available. Thus, by sharing telemetry data across device and provider boundaries, the client experience may be improved in ways that would not otherwise be possible.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 11 schematically shows a simplified representation of a computing system 1100 configured to provide any to all of the compute functionality described herein. Computing system 1100 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 1100 includes a logic subsystem 1102 and a storage subsystem 1104. Computing system 1100 may optionally include a display subsystem 1106, input subsystem 1108, communication subsystem 1110, and/or other subsystems not shown in FIG. 11.

Logic subsystem 1102 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 1104 includes one or more physical devices configured to temporarily and/or permanently hold computer information such as data and instructions executable by the logic subsystem. When the storage subsystem includes two or more devices, the devices may be collocated and/or remotely located. Storage subsystem 1104 may include volatile, nonvolatile, dynamic, static, read/write, read-only, random-access, sequential-access, location-addressable, file-addressable, and/or content-addressable devices. Storage subsystem 1104 may include removable and/or built-in devices. When the logic subsystem executes instructions, the state of storage subsystem 1104 may be transformed—e.g., to hold different data.

Aspects of logic subsystem 1102 and storage subsystem 1104 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 1106 may be used to present a visual representation of data held by storage subsystem 1104. This visual representation may take the form of a graphical user interface (GUI). Display subsystem 1106 may include one or more display devices utilizing virtually any type of technology. In some implementations, display subsystem may include one or more virtual-, augmented-, or mixed reality displays.

When included, input subsystem 1108 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 1110 may be configured to communicatively couple computing system 1100 with one or more other computing devices. Communication subsystem 1110 may include wired and/or wireless communication devices compatible with one or more different communication protocols. The communication subsystem may be configured for communication via personal-, local- and/or wide-area networks.

The methods and processes disclosed herein may be configured to give users and/or any other humans control over any private and/or potentially sensitive data. Whenever data is stored, accessed, and/or processed, the data may be handled in accordance with privacy and/or security standards. When user data is collected, users or other stakeholders may designate how the data is to be used and/or stored. Whenever user data is collected for any purpose, the user data may only be collected with the utmost respect for user privacy (e.g., user data may be collected only when the user owning the data provides affirmative consent, and/or the user owning the data may be notified whenever the user data is collected). If the data is to be released for access by anyone other than the user or used for any decision-making process, the user's consent may be collected before using and/or releasing the data. Users may opt-in and/or opt-out of data collection at any time. After data has been collected, users may issue a command to delete the data, and/or restrict access to the data. All potentially sensitive data optionally may be encrypted and/or, when feasible, anonymized, to further protect user privacy. Users may designate portions of data, metadata, or statistics/results of processing data for release to other parties, e.g., for further processing. Data that is private and/or confidential may be kept completely private, e.g., only decrypted temporarily for processing, or only decrypted for processing on a user device and otherwise stored in encrypted form. Users may hold and control encryption keys for the encrypted data. Alternately or additionally, users may designate a trusted third party to hold and control encryption keys for the encrypted data, e.g., so as to provide access to the data to the user according to a suitable authentication protocol.

When the methods and processes described herein incorporate ML and/or AI components, the ML and/or AI components may make decisions based at least partially on training of the components with regard to training data. Accordingly, the ML and/or AI components may be trained on diverse, representative datasets that include sufficient relevant data for diverse users and/or populations of users. In particular, training data sets may be inclusive with regard to different human individuals and groups, so that as ML and/or AI components are trained, their performance is improved with regard to the user experience of the users and/or populations of users.

ML and/or AI components may additionally be trained to make decisions so as to minimize potential bias towards human individuals and/or groups. For example, when AI systems are used to assess any qualitative and/or quantitative information about human individuals or groups, they may be trained so as to be invariant to differences between the individuals or groups that are not intended to be measured by the qualitative and/or quantitative assessment, e.g., so that any decisions are not influenced in an unintended fashion by differences among individuals and groups.

ML and/or AI components may be designed to provide context as to how they operate, so that implementers of ML and/or AI systems can be accountable for decisions/assessments made by the systems. For example, ML and/or AI systems may be configured for replicable behavior, e.g., when they make pseudo-random decisions, random seeds may be used and recorded to enable replicating the decisions later. As another example, data used for training and/or testing ML and/or AI systems may be curated and maintained to facilitate future investigation of the behavior of the ML and/or AI systems with regard to the data. Furthermore, ML and/or AI systems may be continually monitored to identify potential bias, errors, and/or unintended outcomes.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a network repository comprises: a network communications interface configured to communicatively couple the network repository with a client device, a service entity, and an intermediate network device configured to facilitate a network communication between the client device and the service entity; a logic machine; and a storage machine holding instructions executable by the logic machine to: receive telemetry data for the network communication from a reporting entity including one of the client device, service entity, and the intermediate network device; store the telemetry data; receive, from a requesting entity other than the reporting entity, a request for a set of the telemetry data stored by the network repository; and provide the set of telemetry data to the requesting entity. In this example or any other example, the intermediate network device is a network router. In this example or any other example, the network router is operated by an Internet service provider (ISP), and the telemetry data includes information collected by the ISP while facilitating the network communication between the client device and service entity. In this example or any other example, the telemetry data includes information collected by a manufacturer of the network router. In this example or any other example, the telemetry data includes one or more of a number of packet drops recorded by the network router, an available bandwidth of the network router, and a number of open connections handled by the network router. In this example or any other example, the telemetry data includes a unique device identifier of the reporting entity. In this example or any other example, the unique device identifier is an Internet protocol (IP) address of the reporting entity. In this example or any other example, the telemetry data is stored by the network repository as one or more binary large objects (BLOBs) corresponding to a device type of the reporting entity that provided the telemetry data and a data type of the telemetry data. In this example or any other example, the reporting entity is a management plane device that provides telemetry data pertaining to the intermediate network device. In this example or any other example, the instructions are further executable to receive second telemetry data for the network communication from a second reporting entity including one of the client device, service entity, and the intermediate network device. In this example or any other example, the request for the set of telemetry data stored by the network repository is received via an application programming interface (API) of the network repository. In this example or any other example, the requesting entity is a participant in the network communication between the client device and service entity. In this example or any other example, the set of telemetry data stored by the network repository includes telemetry data received from two or more reporting entities.

In an example, a service entity comprises: a network communications interface configured to communicatively couple the service entity with a client device, a network repository, and an intermediate network device configured to facilitate a network communication between the client device and the service entity; a logic machine; and a storage machine holding instructions executable by the logic machine to: send telemetry data for the network communication to the network repository; send a request for a set of telemetry data regarding the network communication to the network repository, the set of telemetry data including telemetry data provided by one or both of the client device and the intermediate network device; and receive the set of telemetry data from the network repository. In this example or any other example, the request for the set of telemetry data is sent via an application programming interface (API) of the network repository. In this example or any other example, the instructions are further executable to send second telemetry data for the network communication to the network repository. In this example or any other example, the intermediate network device is a network router, and the set of telemetry data includes telemetry data regarding the network communication collected by the network router. In this example or any other example, the set of telemetry data includes one or more of a number of packet drops recorded by the network router, an available bandwidth of the network router, and a number of open connections handled by the network router. In this example or any other example, the network router is operated by an Internet service provider (ISP), and the set of telemetry data further includes information collected by the ISP while facilitating the network communication between the client device and service entity.

In an example, a client device comprises: a network communications interface configured to communicatively couple the client device with a service entity, a network repository, and an intermediate network device configured to facilitate a network communication between the client device and the service entity; a logic machine; and a storage machine holding instructions executable by the logic machine to: send telemetry data for the network communication to the network repository; send a request for a set of telemetry data regarding the network communication to the network repository; receive the set of telemetry data from the network repository, the set of telemetry data including telemetry data provided by either or both of the service entity and intermediate network device; and based on the set of telemetry data, identify one or more potential network changes that, when implemented, are predicted to improve a network experience of the client device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A network repository, comprising:
a network communications interface configured to communicatively couple the network repository with a client device, a service entity, and an intermediate network device configured to facilitate a network communication between the client device and the service entity;
a logic machine; and
a storage machine holding instructions executable by the logic machine to:
receive telemetry data for the network communication from a reporting entity including one of the client device, service entity, and the intermediate network device;
store the telemetry data;
receive, from a requesting entity other than the reporting entity, a request for a set of the telemetry data stored by the network repository; and
provide the set of telemetry data to the requesting entity.

2. The network repository of claim 1, where the intermediate network device is a network router.

3. The network repository of claim 2, where the network router is operated by an Internet service provider (ISP), and the telemetry data includes information collected by the ISP while facilitating the network communication between the client device and service entity.

4. The network repository of claim 2, where the telemetry data includes information collected by a manufacturer of the network router.

5. The network repository of claim 2, where the telemetry data includes one or more of a number of packet drops recorded by the network router, an available bandwidth of the network router, and a number of open connections handled by the network router.

6. The network repository of claim 1, where the telemetry data includes a unique device identifier of the reporting entity.

7. The network repository of claim 6, where the unique device identifier is an Internet protocol (IP) address of the reporting entity.

8. The network repository of claim 1, where the telemetry data is stored by the network repository as one or more binary large objects (BLOBs) corresponding to a device type of the reporting entity that provided the telemetry data and a data type of the telemetry data.

9. The network repository of claim 1, where the reporting entity is a management plane device that provides telemetry data pertaining to the intermediate network device.

10. The network repository of claim 1, where the instructions are further executable to receive second telemetry data for the network communication from a second reporting entity including one of the client device, service entity, and the intermediate network device.

11. The network repository of claim 1, where the request for the set of telemetry data stored by the network repository is received via an application programming interface (API) of the network repository.

12. The network repository of claim 1, where the requesting entity is a participant in the network communication between the client device and service entity.

13. The network repository of claim 1, where the set of telemetry data stored by the network repository includes telemetry data received from two or more reporting entities.

14. A service entity, comprising:
a network communications interface configured to communicatively couple the service entity with a client device, a network repository, and an intermediate network device configured to facilitate a network communication between the client device and the service entity;
a logic machine; and
a storage machine holding instructions executable by the logic machine to:
send telemetry data for the network communication to the network repository;
send a request for a set of telemetry data regarding the network communication to the network repository, the set of telemetry data including telemetry data provided by one or both of the client device and the intermediate network device; and
receive the set of telemetry data from the network repository.

15. The service entity of claim 14, where the request for the set of telemetry data is sent via an application programming interface (API) of the network repository.

16. The service entity of claim 14, further comprising sending second telemetry data for the network communication to the network repository.

17. The service entity of claim 14, where the intermediate network device is a network router, and the set of telemetry data includes telemetry data regarding the network communication collected by the network router.

18. The service entity of claim 17, where the set of telemetry data includes one or more of a number of packet drops recorded by the network router, an available bandwidth of the network router, and a number of open connections handled by the network router.

19. The service entity of claim 17, where the network router is operated by an Internet service provider (ISP), and the set of telemetry data further includes information collected by the ISP while facilitating the network communication between the client device and service entity.

20. A client device, comprising:
a network communications interface configured to communicatively couple the client device with a service entity, a network repository, and an intermediate network device configured to facilitate a network communication between the client device and the service entity;
a logic machine; and
a storage machine holding instructions executable by the logic machine to:
send telemetry data for the network communication to the network repository;
send a request for a set of telemetry data regarding the network communication to the network repository;
receive the set of telemetry data from the network repository, the set of telemetry data including telemetry data provided by either or both of the service entity and intermediate network device; and
based on the set of telemetry data, identify one or more potential network changes that, when implemented, are predicted to improve a network experience of the client device.
